(19) United States
(12) Patent Application Publication
(10) Pub. No.: US 2002/0106235 A1
(43) Pub. Date: Aug. 8, 2002

(54) System for organizing, planning and motivating schoolwork and the like

(76) Inventor: Columbia E. Perry Jones, Atlanta, GA (US)

Correspondence Address: Columbia E. Perry Jones, 120 Alden Ave. NW # E-3, Atlanta, GA, 30309, US

(21) Appl. No.: 09/920,087

(22) Filed: Jul. 31, 2001

Related U.S. Application Data
(60) Provisional application No. 60/221,745, filed on Jul. 31, 2000.

(51) Int. Cl. B42F 13/00

(52) U.S. Cl. 402/73

(57) ABSTRACT

A method and apparatus for assisting students and the like in organizing, and keeping organized, papers and materials for schoolwork and the like. Users will be able to place papers which will be needed at a future time, in a specific labeled, location for easy retrieval at a later time. The system motivates the initiation of work on a particular task, in a timely manner, because lost papers or materials are no longer an obstacle to beginning the task. This system and method comprises a short term, portable, sorting and filing system, a long term filing system and a linking device which encourages the user to consider specifically what to keep and what to discard. The system makes it obvious how and where to place items selected to keep. The system provides an organized group of places immediately available for things which need to be stored, short term and long term, for easy future retrieval. The system provides tools and training for time management. The system also encourages and instructs the user in building lifelong habits of being organized.

### CROSS-REFERENCE TO RELATED U.S. PROVISIONAL PATENT APPLICATION

This application claims the benefit of U.S. Provisional Patent Application No. 60/221,745, filed on Jul. 31, 2000.

### BACKGROUND OF THE INVENTION

Many students do poorly in school, not because they lack the intelligence needed to do the work well, but because they lack the organizational skills to work efficiently and to do work in a timely manner. Assignments are lost or incomplete. Completed homework is often turned in late, or not at all, causing the student to get a lower grade, or a zero, on the assignment. Sometimes the assignment was done, but never makes it back to school, to be turned in. Sometimes the assignment was not completed, and on other occasions it was not begun at all. In cases where the student does not begin at all, it is often because they have not written down the assignment or have misplaced a worksheet or direction sheet, necessary for completing the work. Students who experience this type of difficulty often become discouraged, and put forward less effort or give up altogether. What is needed is an easy, step by step system including a comprehensive filing system for keeping on task, along with a training program under which the system is ingrained into the students' memory through repetition, and physical motion, and aided by the use of colors, shapes and the like. It is also motivating if the student can actually see a representation of what he or she has to do next, or has accomplished.

Applicant posses a background of training and application in psychology and education and has successfully utilized this system for most of the past year, and the system has been universally praised. While some of the physical parts of the system have been used before, applicant has been told over and over by clients that this system is both unique, and extremely effective. Many students show extreme improvement in their ability to stay organized literally the day following the beginning of their use of the system. Students report “Now its so easy to stay organized”.

Applicant has conducted a search and has found no prior art that has put all of these elements together. U.S. Pat. No. 6,006,215 does not provide a training program for students (or memory) and other people with study or focus problems. U.S. Pat. Nos. 5,601,432, 5,366,248 and 4,659,109 address only a portion of the problems, but not thoroughly.

### OBJECTS AND ADVANTAGES

The primary object of this invention is to provide for students a system and means to organize schoolwork on a daily basis, to get homework completed on time and store notes and materials that are complete, make it easy to begin to study, and to do it in such a way that the students can become trained to operate in an organized and efficient manner. This invention offers the advantage of being coordinated with a training program which has, in the past and is in the present, proving very successful. It does not require the use of computers and/or other technical devices. and beyond computer) The fact that our system has substantial advantages over computer programs, is dramatically demonstrated by the fact that the first two schools to implement our system on a school wide basis, are both “laptop schools” (meaning each student has his or her own laptop computer which is used only by that student throughout the entire day). Both schools felt that they needed our system along with the computer to give students a complete organizational system.

The invention has an advantage over assistive devices in that it uses otherwise basic materials which fit into a training program which can be utilized for all students, inclusive of those with impairments, and those with normal organizational skills.

The invention, as a storage system, is far superior to other storage units or systems. The system comprises a short term element with several sorting devices, which are used in a unique manner for the purpose of deciding what to keep and what to throw out. These devices for example, dividers serve not only as sorting devices, but as a holding area for the student to reflect for an appropriate amount of time on his decisions for the two categories keep and throw out. This process is instrumental in the student learning how to use these to categories and can save teacher aggravation with students who have decided to throw something out from getting out of their seats to go to the trash can. The long term system has devices for sorting and organizing for test and final exam preparation, teacher analysis, portfolio presentation and the like.

### SUMMARY

In the present invention, which is both a system and a method, for students and the like to keep organized their papers and the like. It comprises a short term, portable, sorting and filing system, a long term filing system and a linking device which is a system for sorting and determining destination of contents. It further comprises a method of sorting schoolwork and the like, and storing appropriate papers and materials.

### BRIEF DESCRIPTION

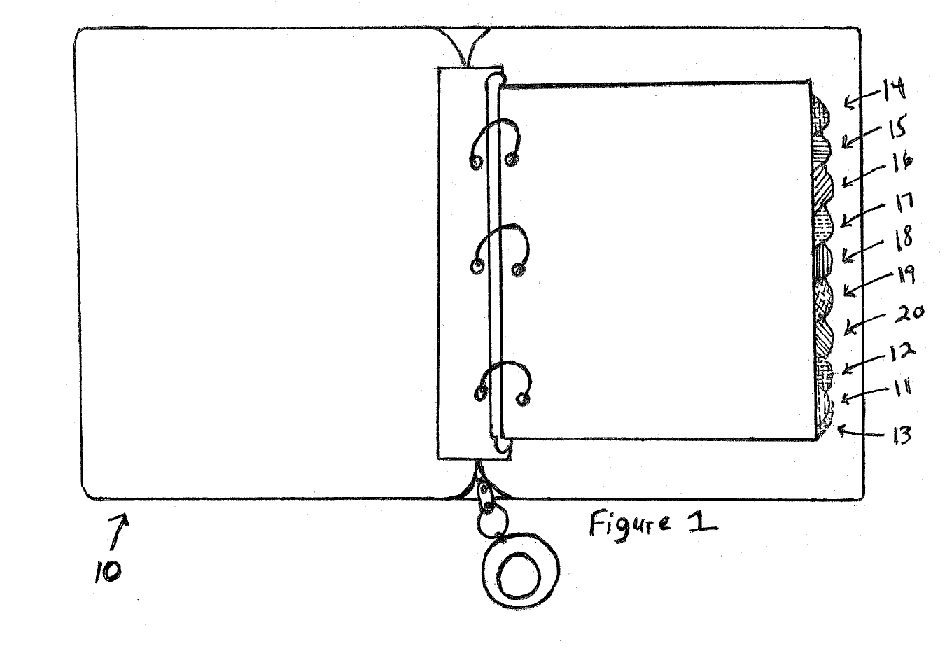

FIG. 1 shows open binder with dividers.

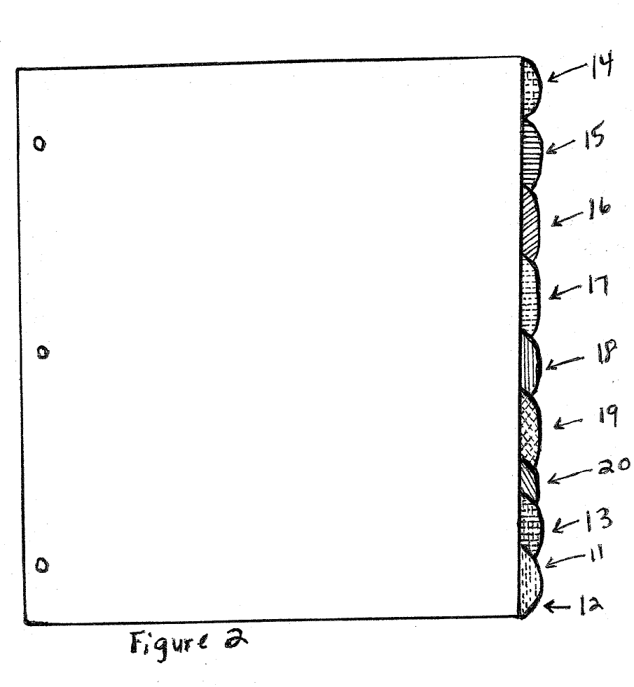

FIG. 2 shows dividers.

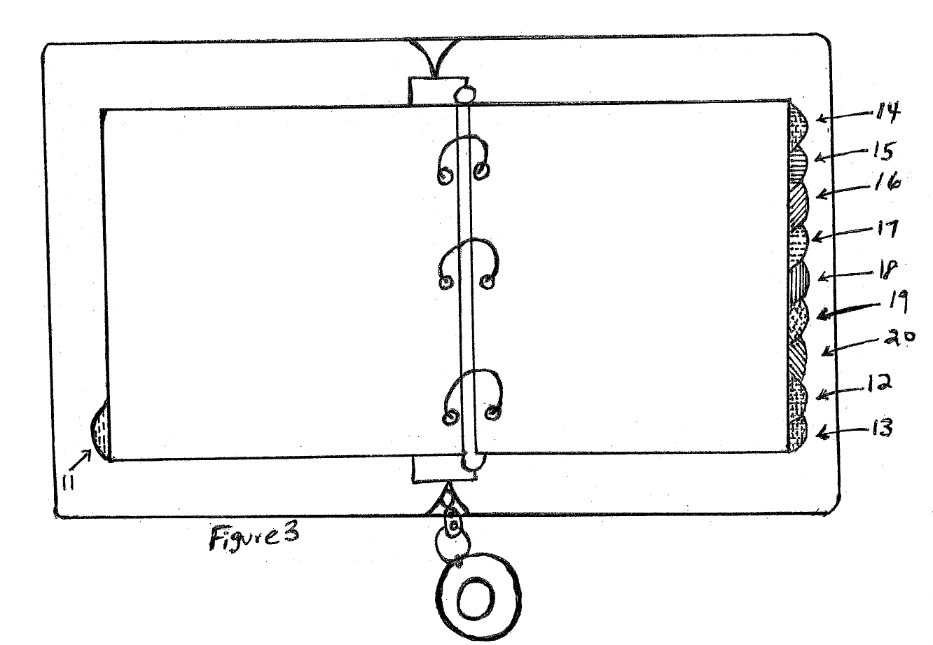

FIG. 3 shows open binder with set of dividers, one divider turned.

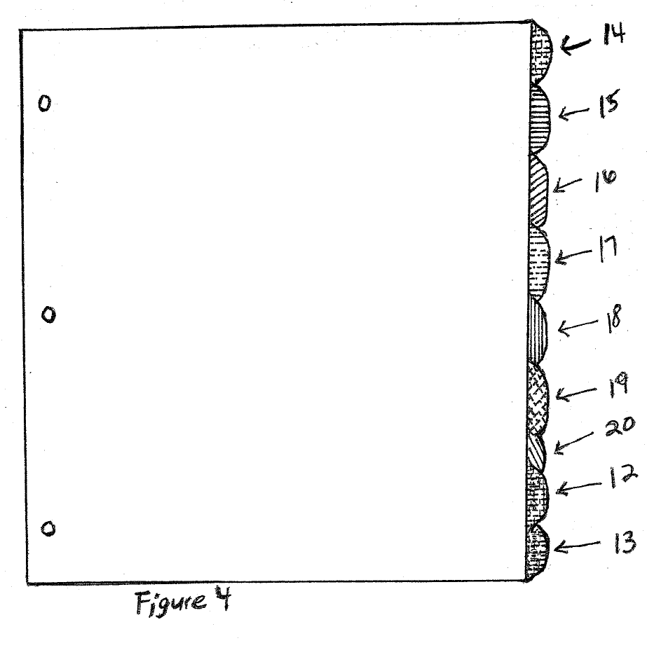

FIG. 4 shows dividers without first divider.

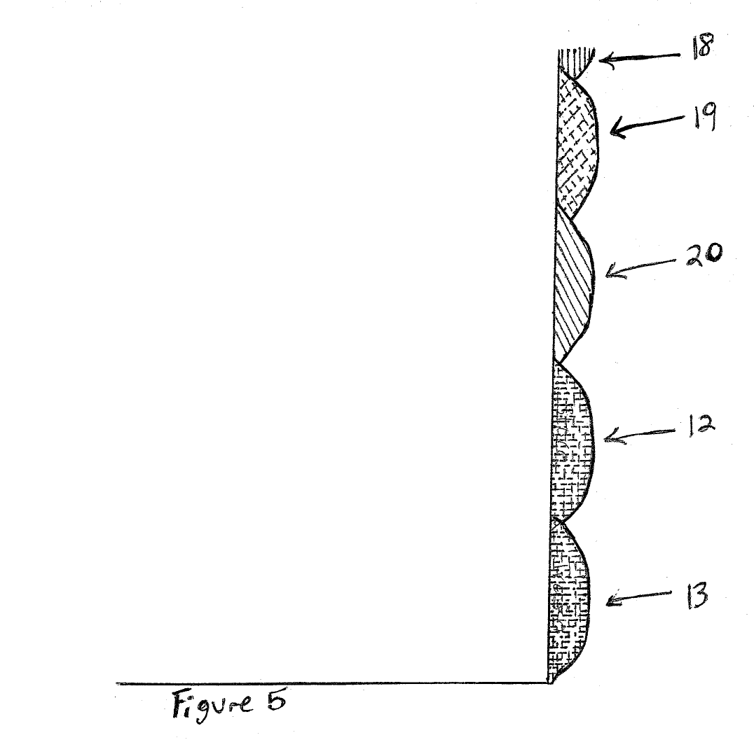

FIG. 5 shows blow-up of dividers with messages

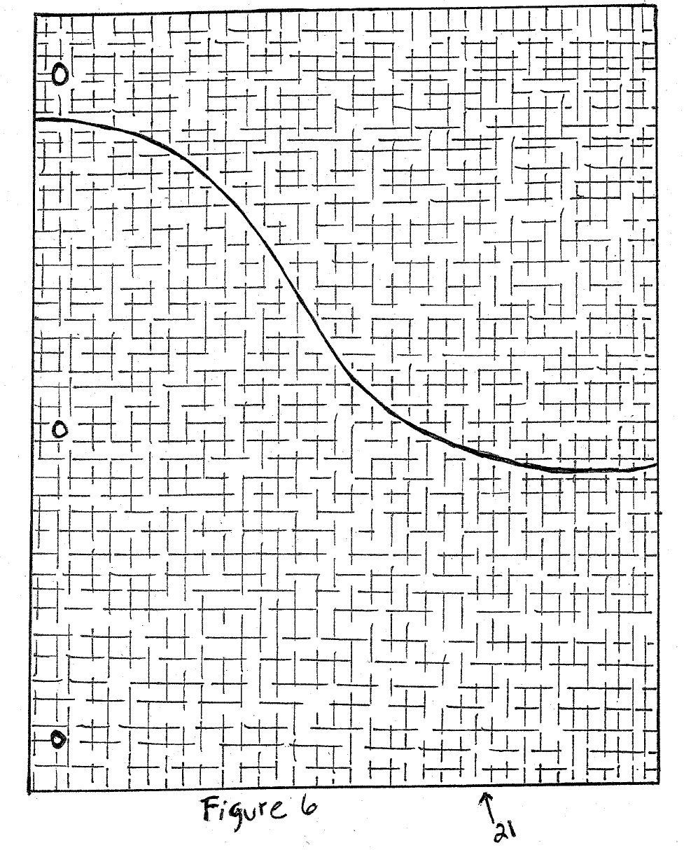

FIG. 6 shows pocket with “To Do” as example of first message.

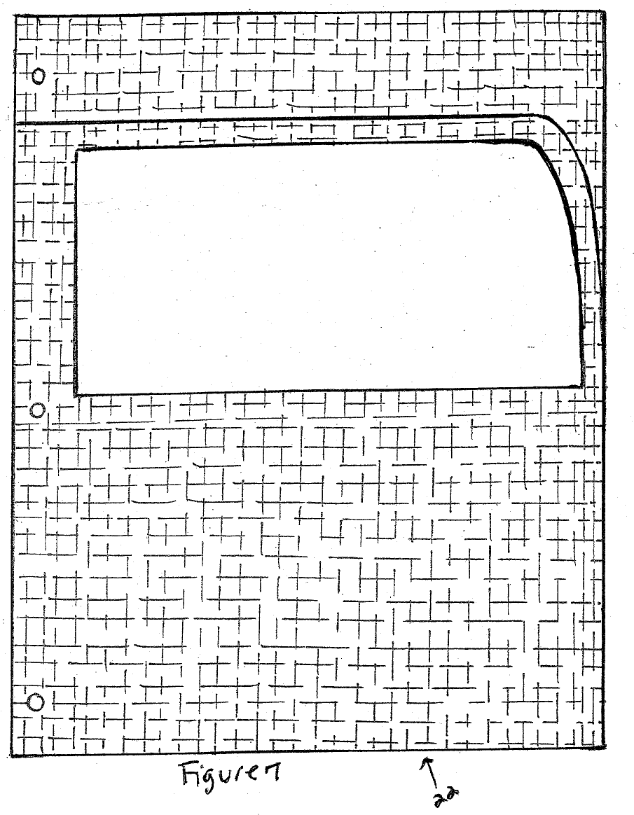

FIG. 7 shows pocket with “Turn In” as example of first message.

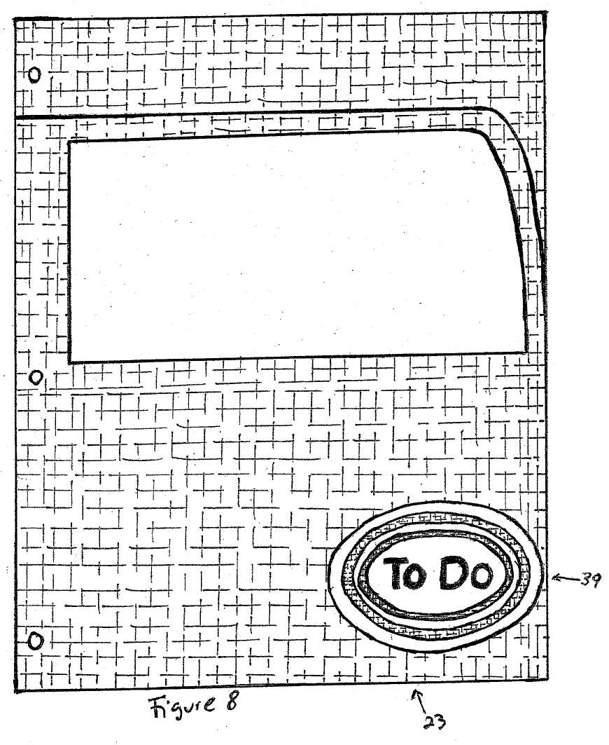

FIG. 8 shows alternative pocket with “To Do” as example of first message.

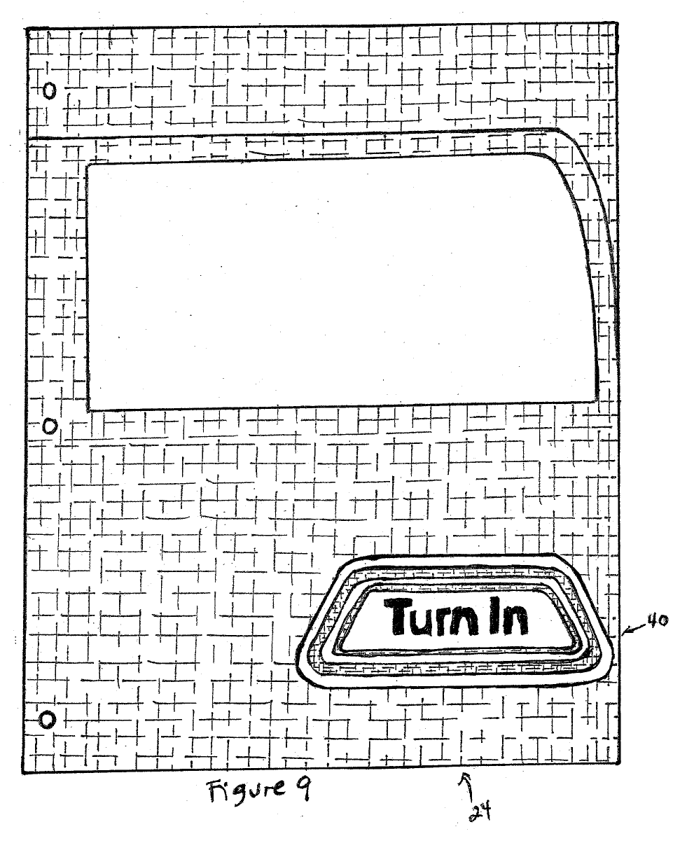

FIG. 9 shows alternative pocket with “Turn in” as example of first message.

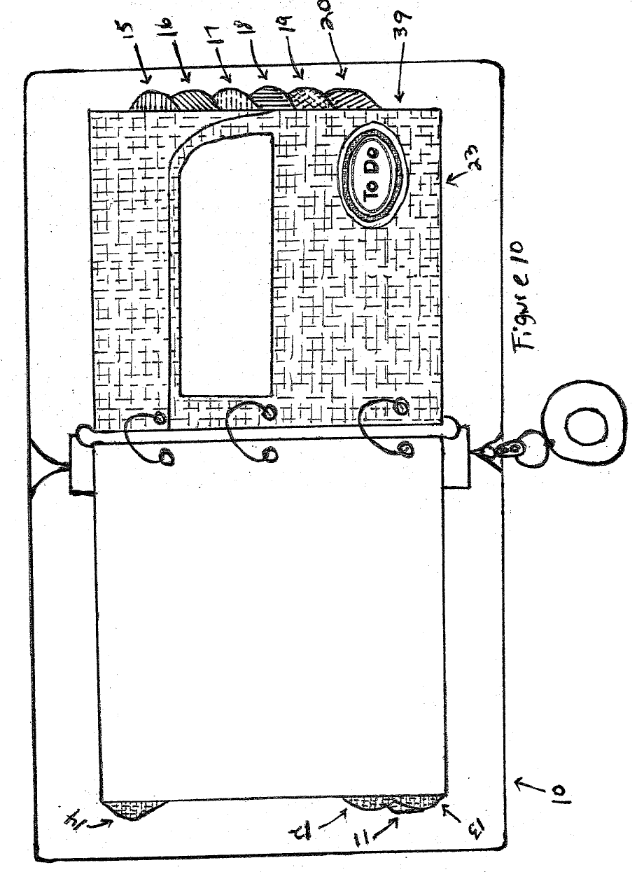

FIG. 10 shows binder opened to yellow “To Do” windowed pocket.

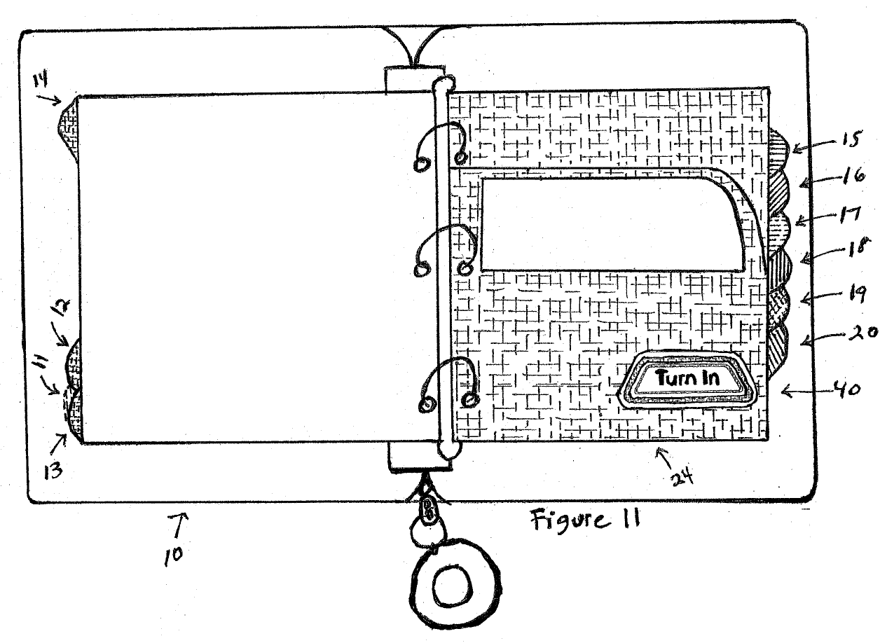

FIG. 11 shows binder opened to yellow “Turn In” windowed pocket.

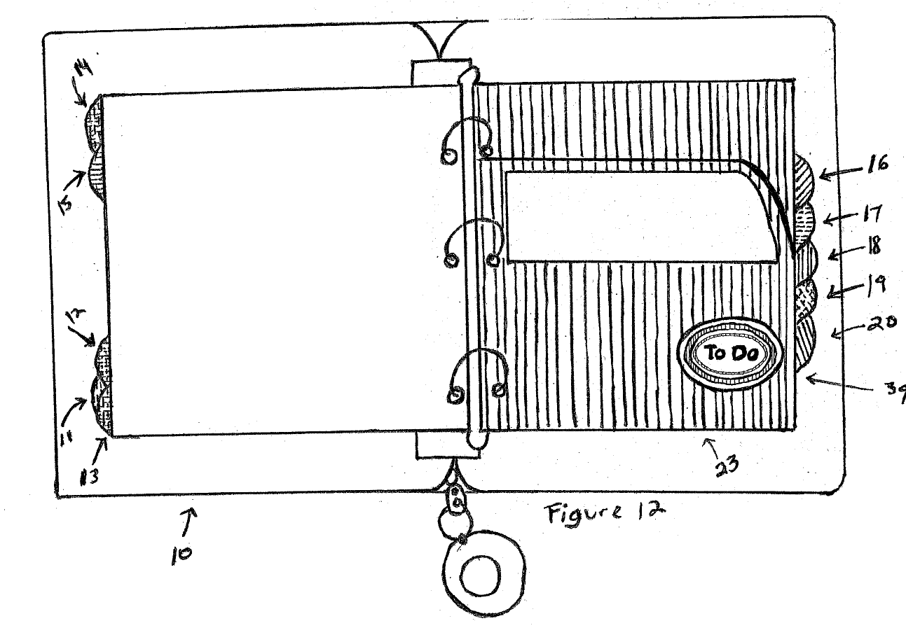

FIG. 12 shows binder opened to red “To Do “windowed pocket

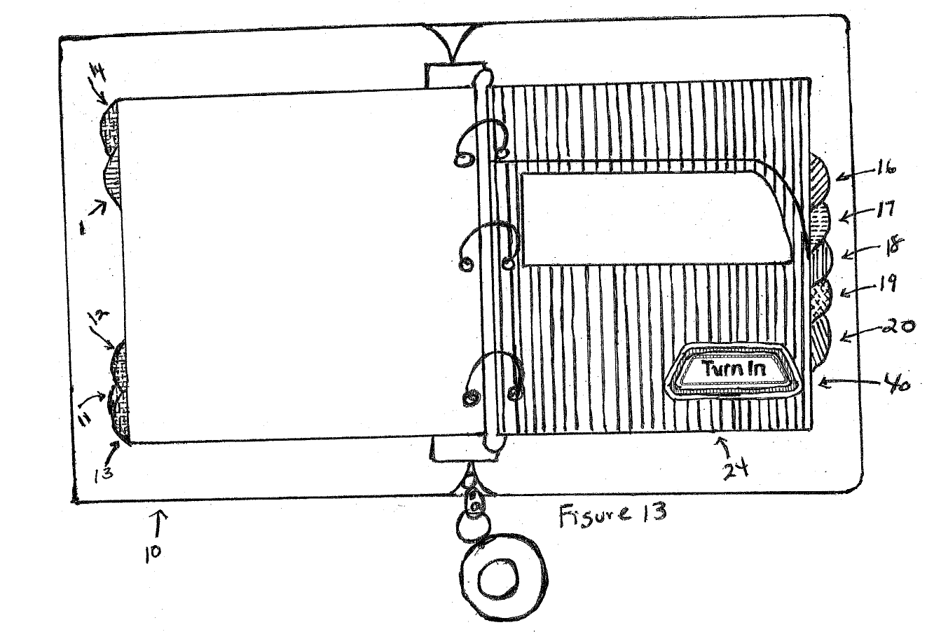

FIG. 13 shows binder opened to red “Turn In” windowed pocket.

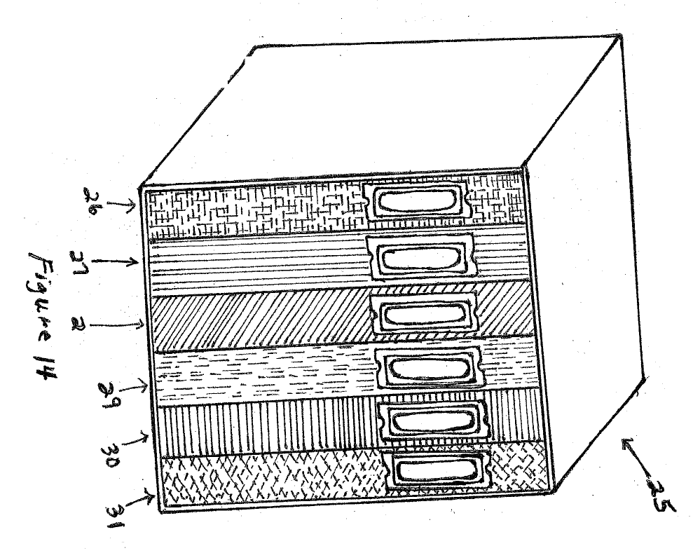

FIG. 14 shows angled front view of “Storage holder” in case.

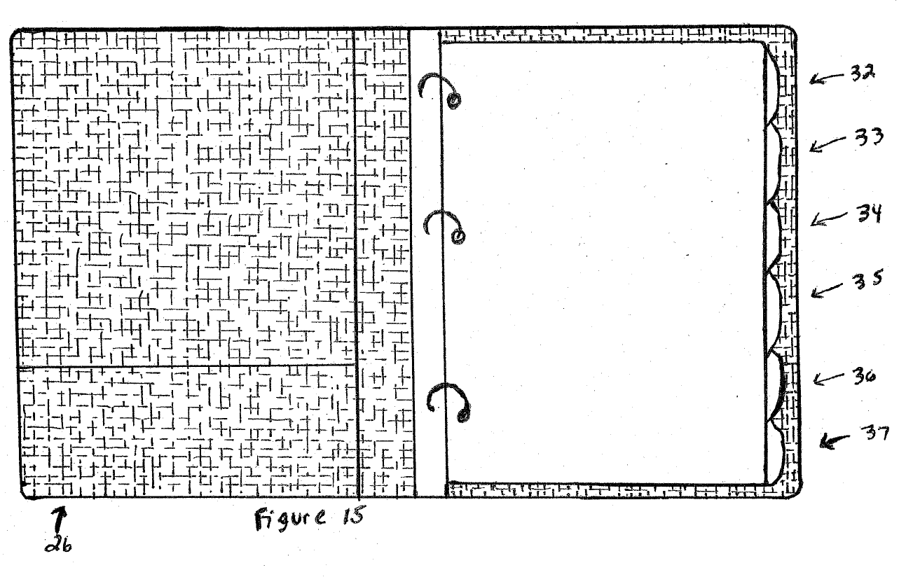

FIG. 15 show open storage holder with dividers.

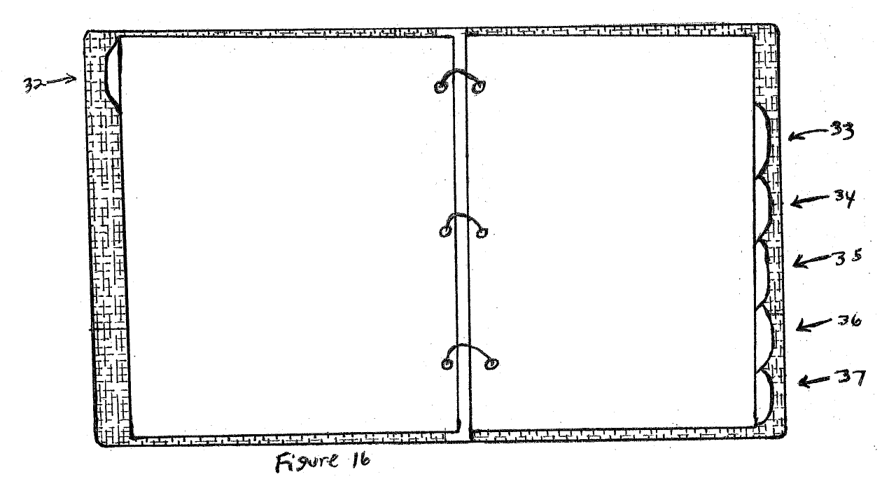

FIG. 16 shows open storage holder with one divider turned.

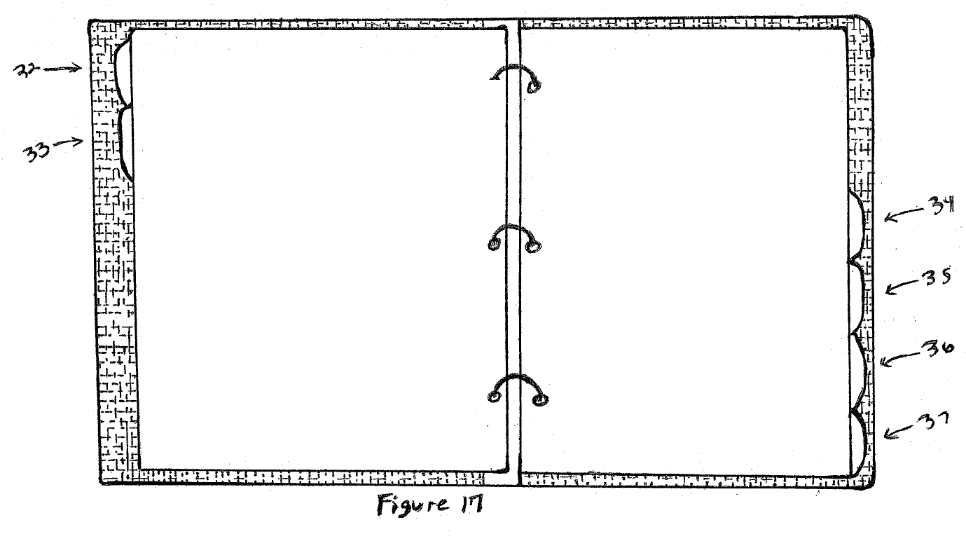

FIG. 17 shows open storage holder with two dividers turned.

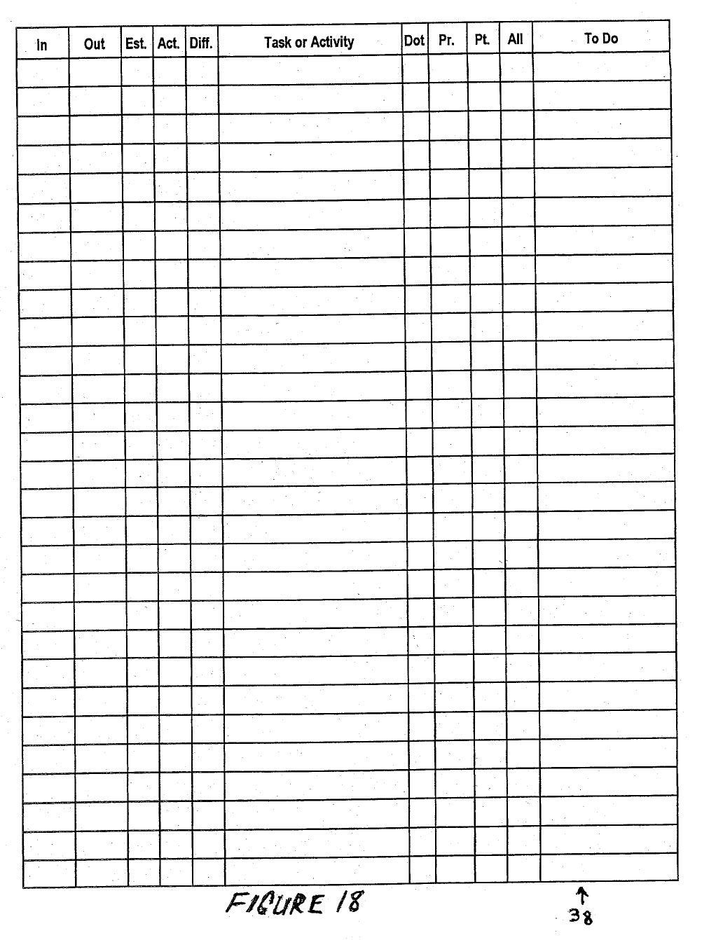

FIG. 18 shows organizing, planning and motivating log.

### DETAILED DESCRIPTIONS

A preferred embodiment of the present invention is its commercial use in conjunction with a proven training program having the effects of creating and supporting habits that will enable the student on his own to beneficially utilize the organizational system after the training program has terminated.

The organizational system is comprised of a short term portable filing system and a long term filing system.

The preferred embodiment is used with students and is described as follows:

FIG. 1 shows open binder (10) with zipper and “hang tag”, and dividers in front to back sequence. The first divider (11) is a gray divider for calendars and assignment sheets. The second divider (12) is a yellow divider for “Store”. The third divider (13) is a yellow divider for “Trash”. The fourth divider (14) is a yellow subject divider. The fifth divider (15) is a red subject divider. The sixth divider (16) is a green subject divider. The seventh divider (17) is a purple subject divider. The eighth divider (18) is a blue subject divider. The ninth (19) is an orange divider for subject. The tenth (20) is a brown subject divider.

FIG. 2 shows dividers (11-20) in sequence from front to back.

FIG. 3 shows open binder (10) with gray calendar and assignment divider (11) turned to the left, revealing yellow “Trash” divider (13), as well as placement of other dividers (12, 14-20)

FIG. 4 shows dividers 12-20 in sequence, without gray divider.

FIG. 5 shows “blow up” of dividers 12 and 13, with store” and “Trash” as examples of messages 3 and 4 in front of subject dividers 18, 19 and 20.

FIG. 6 shows pocket (21) with “To Do” as example of message 1.

FIG. 7 shows pocket (22) with “Turn In” as example of message 2.

FIG. 8 shows alternative pocket (23) with “To Do” as example of message 1.

FIG. 9 shows alternative pocket (24) with “Turn In” as example of message 2.

FIG. 10 shows binder (10) opened to the front of the yellow “To Do” windowed pocket (23) on the right and the back of the yellow subject divider (14) on the left.

FIG. 11 shows binder (10) opened to the front of the yellow “Tumr in” windowed pocket (24) on the right, with red subject divider (15) behind it.

FIG. 12 shows binder (10) opened to the front of the red “To Do” windowed pocket (25) on the right, with the back of the red subject divider (15) on the left.

FIG. 13 shows binder (10) opened to red “Turn In” windowed pocket (26) on the right, with green subject divider (16) behind it.

FIG. 14 showsangled front view of “Storage holders” (28-33) in storage case (27).

FIG. 15 show open storage holder (28) with front to back view of dividers (34-39).

FIG. 16 shows open storage holder (28) with first or front divider (34) tumed.

FIG. 17 shows open storage holder (28) with dividers first or front two dividers 34, 35) turned.

FIG. 18 shows organizing, planning and motivating log (40).

An additional embodiment comprises of the materials comprising the preferred embodiment, packaged with directions as to the utilization of the organizational filing and storage systems on an individual basis without the aid of an organizational training program.

An additional embodiment is paper management system, which further comprises a time management sheet for systematically listing a user's estimate of time required to complete individual tasks before papers held in the pocket holder labeled “TO DO” are ready to be re-categorized and transferred to the pocket holder labeled “TURN IN”.

### Method

Method Provides a Structured Set of Brief Simple Steps.

The First Step.

Students are allowed to choose the color they use for a particular subject (if teachers allow). Choice is good for motivation. Once they have made a color selection for each subject, the rest of the directions papers will move is structured by the system. By following the path provided for each kind of paper they receive, they learn how to keep papers in order, what to keep and what to throw out, and how to collect, and put in order, papers they will need to study for tests and exams. The system itself guides students to where papers should go-at any given time once they have learned the pathway. Not having to figure out where to put the papers can be very motivating to the students and causes them to be more efficient.

After choosing colors for each subject, the next step is making and applying labels for calendar, assignment, “communications with parents” and each subject.

### Operation

The areas set off by dividers used for calendars and assignments alert the student to where he is on the calendar and helps him plan his time effectively for studies and other activities.

The pre-sorting mechanism comprises the “Store” and “Trash” areas and allow the student to utilize small segments of time to clear papers from the daily use areas which comprise the other divider and pockets. The student can, under direction of the teacher or parent, or on his own, discard the items in the “Trash” area, and file in his home storage portion of the system, the things he will need to study for tests and exams. The system guides the student in placement because the holder in the storage system is color coded to the subject divider and pockets in the binder. The system further directs the student, once he has opened the proper color coded holder for the subject of the paper he has in his hand to place that paper behind one of several category labeled dividers. The sorting and placing activity give the student a visual-spatial memory of where the papers are located and that enhances memory of both location and the contents of the paper. When it is time to study for final exams, the student is motivated by the ability to select one holder and have everything right there

What is claimed is:

1. An educational tool comprising:
(a) a short term, portable filing system having a binder, at least two dividers and at least two sets of pocket folders, each set being paired with one of the dividers; each set including two pocket folders which are labeled with first and second task-oriented messages, respectively; the pocket folders within each set and the divider with which the set is paired being distinguishable from the other set and the other divider on the basis of color coding; the binder having front and back portions, a spine interconnecting said front and back portions, and means, secured to the spine, for engaging a lateral edge of each divider and of each pocket folder held by the binder; and
(b) a long term filing system including a plurality of holders, each holder being paired with one of the sets of pocket folders by color coding, each holder containing an array of dividers and files, a divider separating each adjacent pair of files and being labeled according to subject categories.

2. The educational tool according to claim 1 which further comprises at least one presorting device which includes two dividers which are labeled with third and fourth task-oriented messages, respectively; one of the dividers of the presorting device being used to temporarily store papers to be discarded; the engaging means also engaging a lateral edge of each divider of the presorting device, when said device is held in the binder.

3. The educational tool according to claim 1, wherein the first message with which one of the two pocket folders in each set is labeled is “TO DO”, and the second message with which the other pocket folder is labeled is UTURN IN”.

4. The educational tool according to claim 3, wherein the third message with which one of the dividers in the presorting device is labeled is “STORE”, and the fourth message with which the other divider in said presorting device is labeled is “TRASH”.

5. The educational tool according to claim 1, wherein each pocket folder has front and back leaves joined along said lateral edge held by the binder, the front leaf defining a truncated corner which is situated distal from said lateral edge, so that a user can readily ascertain whether the pocket folder is empty.

6. The educational tool according to claim 1, wherein each pocket folder has front and back leaves joined along said lateral edge held by the binder, the front leaf defining at least one cutout, so that a user can look into pocket folder through the cutout and readily ascertain whether the pocket folder is empty.

7. The educational tool according to claim 1 which further comprises at least one presorting device which includes two pocket folders, the pocket folders of the presorting device being distinguishable from said sets of pocket folders, the two pocket folders of the presorting device being labeled with third and fourth task-oriented messages, respectively; one of the pocket folders of the presorting device being used to temporarily store paper to be discarded; the engaging means also engaging a lateral edge of each pocket folder of the presorting device when said device is held in the binder.

8. A paper management system, comprising:
(a) a short term, portable filing system having a binder, at least two dividers and at least two sets of pocket folders, each set being paired with one of the dividers; each set including two pocket folders which are labeled with first and second task-oriented messages, respectively; the pocket folders within each set and the divider with which the set is paired being distinguishable from the other set and the other divider on the basis of color coding; the binder having front and back portions, a spine interconnecting said front and back portions, and means, secured to the
